(19) United States
(12) Patent Application Publication
(10) Pub. No.: US 2003/0134156 A1
(43) Pub. Date: Jul. 17, 2003

(54) High density piezoelectric thick film and manufacturing method thereof

(76) Inventors: Tae Song Kim, Seoul (KR); Yong Bum Kim, Seoul (KR); Chae Il Cheon, Seoul (KR)

Correspondence Address: Raj S. Dave, Morrison & Foerster LLP, Suite 5500, 2000 Pennsylvania Avenue N.W., Washington, DC, 20006-1888, US

(21) Appl. No.: 10/152,977

(22) Filed: May 23, 2002

(30) Foreign Application Priority Data
May 26, 2001 (KR) 29272/2001

(51) Int. Cl. B32B 15/00

(52) U.S. Cl. 428/702; 428/469

(57) ABSTRACT

A method for manufacturing a high density piezoelectric thick film includes the steps of: mixing and dispersing piezoelectric material powder and a sol in a vehicle made of an organic binder and solvent, to fabricate a paste; printing the paste to a thickness of 5-100 micron on a substrate by a screen printing, to form a thick film; drying the thick film, and thermally treating the thick film.

### BACKGROUND OF THE INVENTION

1. Field of the Invention

The present invention relates to a high density piezoelectric thick film and its manufacturing method, and more particularly, to a method for manufacturing a high density piezoelectric thick film that has a basic composition of Pb(CdW)O₃—PbTiO₃—PbZrO₃ while having a low reactivity with a bottom substrate, by using a screen printing method.

2. Description of the Background Art

A method for fabricating a piezoelectric thick film by using the screen printing method has an advantage that no patterning is necessary to manufacture a thick film having an excellent piezoelectricity or ferroelectricity and a thick film of a desired pattern size can be directly formed, while having a problem that it is difficult to obtain its densification.

Especially, in case of forming a piezoelectric thick film to be used as a micro electro mechanical system (MEMS) device on a silicon substrate, since Pb(Zr, Ti)O₃ (PZT) type component and the lower silicon are reacted at a temperature of higher than 800° C., degrading the piezoelectricity characteristic of the thick film, the densification should be accomplished at a low temperature if possible.

In order to overcome the problem, before depositing a thick film, a diffusion barrier layer is used between the lower electrode and the silicon substrate to accomplish a densification. Or, in order to enhance the densification while performing a process at a low temperature, when a paste is fabricated for screen printing process, glass phase which may be easily melt and fill the space between particles of the paste is added or pressurization thermal treatment (ex: Hot Isotropic Pressing Treatment) is performed during a thermal treatment.

Meanwhile, in case of manufacturing a thick film having Pb(Zr,Ti)O₃ (PZT), one of ceramic materials as a basic composition, many researches have been conducted to apply its characteristics to a micro-device due to its piezoelectricity and pyroelectricity characteristics.

Koch et al. did a research to manufacture a thick film by adding a 5% borosilicate glass, a glass phase, to a paste [Sensors and Actuators A, 70 (1998) 98-103].

Chen et al. conducted a research to achieve two goals of a densification and a low temperature co-firing by adding 4% LiCO₃ and Bi₂O₃ and forming a glass phase [J. of Appl. Phys, 77(1995) 3349-3353].

Yao et al. conducted a research to obtain a densification of a PZT thick film on an alumina substrate by performing a isostatic pressing after a screen printing [Sensors and Actuators A.71 (1998) 139-143]. However, since the thermal treatment temperature was as high as 1130° C., it is also a restriction to be applied to a micro-device forming a film on a Si thin film (wafer).

As another method for a densification, a sol made of the same material is mixed with ceramic powder to manufacture a thick film. Since the added sol fills the empty space between particles, a densified film can be fabricated.

Barrow et al. attempted this method to form a thick film by mixing PZT power and PZT sol and deposit a film having a thickness of 20 μm at a low temperature of 650° C. [J. of Appln. Phys, 81 (1997) 876-881].

However, such a method is disadvantages in that a post-process is required in which a film is patterned by using a suitable mask and etched to pattern it to a desired size, and since sol and the ceramic particles are separated during a coating by using the sol, failing to form a uniform film.

In other aspect, since manufacturing of a thick film is largely dependent on the characteristics of its basic material, a densification can be also basically accomplished by using a low temperature co-firing characteristic of the piezoelectric film itself besides the method for obtaining a densification according to the process development as described above.

Since BaTiO₃ was first used as a piezoelectric material, Pb(Zr,Ti)O₃ type, a piezoelectric material having an excellent piezoelectric characteristic, has been discovered and widely used up to now.

Especially, Pb(CdW)O₃—PbTiO₃—PbZrO₃ or the like is widely known as a piezoelectric material which has a high mechanical quality coefficient and a low resonance frequency as a bulk device such as a ceramic resonator or a ceramic filter for use in an acoustic instrument or a communication instrument.

And as a method for lowering a sintering temperature, a piezoelectric material made by having the piezoelectric material as a basic composition and adding MnO₂ or Cr₂O₃ as a sub-component thereto is widely known.

However, the piezoelectric material is used to manufacture a bulk ceramic piezoelectric component, for which about 1050° C. is the optimum thermal treatment temperature, whereas as for the manufacturing of the thick film as described above, if the sintering temperature is higher than 1000° C., a mutual diffusion reaction with a semiconductor such as silicon occurs or a lead (Pb) component is volatilized in sintering or integrating the thick film, making it difficult to manufacturing it. In addition, if the sintering temperature is lowered down by adding a densification enhancing agent, the piezoelectric characteristic of the thick film is degraded due to the influence of impurities.

### SUMMARY OF THE INVENTION

Therefore, an object of the present invention is to provide a method for manufacturing a high density piezoelectric thick film having a low reactivity with a bottom substrate while having Pb(CdW)O₃—PbTiO₃—PbZrO₃ as a basic component for a piezoelectric material by using a low temperature co-firing characteristic of a basic piezoelectric film.

To achieve these and other advantages and in accordance with the purpose of the present invention, as embodied and broadly described herein, there is provided a high density piezoelectric thick film of which a composition of a piezoelectric material is Pb(Zr,Ti)O₃+xPb(Cd_{1/2}W_{1/2})O₃(x=0.01−0.20).

In this respect, if the value of ‘X’ is greater, though the thick film may be sintered at a lower temperature, the piezoelectric characteristic of the thick film is degraded as much.

To achieve the above objects, there is also provided a method for manufacturing a high density piezoelectric thick film including the steps of: mixing and dispersing piezoelectric material powder and a sol having the same or a similar component as or to that of the piezoelectric material powder in a vehicle made of an organic binder and solvent, to fabricate a paste; printing the paste to a thickness of 5-100 micron on a substrate by a screen printing, to form a thick film; drying the thick film, and thermally treating the thick film.

To achieve the above objects, there is also provided a method for manufacturing a high density piezoelectric thick film including the steps of: mixing and dispersing piezoelectric material powder in a vehicle made of an organic binder and solvent, to fabricate a paste; printing the paste to a thickness of 5-100 micron on a substrate by a screen printing, to form a thick film; drying the thick film and removing the organic binder; coating and infiltrating a sol solution having the same or a similar component as or to that of the piezoelectric material powder on the surface of the printed thick film; spinning a test sample to remove a residual sol solution; drying and intermediately thermally treating the thick film; and thermally treating the thick film

To achieve the above objects, there is also provided a method for manufacturing a high density piezoelectric thick film including the steps of: mixing and dispersing piezoelectric material powder and a sol having the same or a similar component as or to that of the piezoelectric material powder in a vehicle made of an organic binder and solvent, to fabricate a paste; printing the paste to a thickness of 5-100 micron on a substrate by a screen printing, to form a thick film; drying the thick film and removing the organic binder; coating and infiltrating a sol solution on the surface of the printed thick film; spinning the thin film test sample to remove a residual sol solution; drying and intermediately thermally treating the thick film; and thermally treating the thick film.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B are drawings illustrating a polarization-electric field (P-E) hysteresis curve for a test sample (thermal treatment temperature: 800° C.) before and after sol-process of a pure PZT thick film;

FIGS. 2A and 2B are drawings illustrating a polarization-electric field (P-E) hysteresis curve for a test sample (thermal treatment temperature: 800° C.) before and after sol-process of a PZT-0.08PCW thick film in accordance with a preferred embodiment of the present invention;

FIG. 3A is a drawing illustrating a polarization-electric field (P-E) hysteresis curve for a test sample (thermal treatment temperature: 950° C.) deposited by a screen printing before a sol-process of a PZT-0.08PCW thick film in accordance with the preferred embodiment of the present invention;

FIG. 3B is a drawing illustrating a polarization-electric field (P-E) hysteresis curve for a bulk PZT-0.08CW sample (thermal treatment temperature: 950° C.); and

FIG. 4 is an SEM photograph showing a section of the thick film deposited by the method in accordance with the preferred embodiment of the present invention (film thickness: 28 μm).

### DETAILED DESCRIPTION OF THE PREFERRED EMBODIMENTS

In the method for manufacturing a high density piezoelectric thick film of the present invention, the piezoelectric material powder has the basic component of Pb(Zr,Ti)O₃+xPb(Cd_{1/2}W_{1/2})O₃(x=0.01−0.20).

In this respect, if the value of ‘X’ is greater, though the thick film may be sintered at a lower temperature, the piezoelectric characteristic of the thick film is degraded as much.

As for the thermal treatment, the thick film is sintered at a temperature of 750-950° C. for 1-30 minutes, or quickly thermally treated within 20 seconds at a temperature of 1000-1200° C.

Forming a film at a low temperature is to prevent a possibility that a substance movement occurs from a film to a substrate or from a substrate to a film when it is subjected to a thermal treatment for a predetermined time period at a high temperature. In addition, if the thermal treatment is performed for a long period of time, a problem would arise that the film is curved or broken due to the difference of thermal expansion coefficient. Thus, instead of this method, a method for rapidly thermally treating the film at a relatively high temperature to obtain a desired characteristic while not allowing a time for the film and the substrate to react each other is used.

As mentioned above, the sol has the same composition as that of the piezoelectric material powder used for manufacturing the paste or has a similar composition to that of the piezoelectric material powder in which a sol having a different composition is added for a particular purpose.

For example, since the film is thermally treated at a high temperature, an extra 10-20% PbO may be added or a sol having a different ratio of Zr/Ti among the component may be added.

In the method for manufacturing a high density piezoelectric thick film of the present invention, as the substrate, besides the silicon substrate, there may be used a ceramic and a single crystal substrate such as ZrO₂ or Al₂O₃, a ceramic substrate with a metal such as platinum coated thereon, or a metal substrate with ceramic coated thereon.

Preferred embodiments of the present invention will now be described, but not limited thereto.

Embodiment 1

In manufacturing a ceramic thick film, in order to apply a screen printing method, a film is to be prepared in a paste form made of a material desired to be deposited.

The general Pb(CdW)O₃—PbTiO₃—PbZrO₃ paste is manufactured through a process in which a piezoelectric material powder of Pb(Zr,Ti)O₃+xPb(Cd_{1/2}W_{1/2})O₂(x=0.01-0.2) is mixed and dispersed in the basic composition of Pb(CdW)O₃—PbTiO₃—PbZrO₃, a characteristic implementing material, in a vehicle comprising an organic binder and a solvent

First, the vehicle was manufactured in such a manner that a butoxy ethoxy ethyl acetate (BEEA) resin, a polyvinyl butyral (PVB) resin or a polyethylene glycol resin was completely dissolved in a α-terpineol, the basis, which is widely adopted as a solvent of a paste.

In the present invention, a sol was freshly added besides the general component according to the manufacturing of the paste.

The sol was fabricated by the typical sol manufacturing process, and had the same composition as that of the piezoelectric material powder used for manufacturing of the paste or had a similar composition to that of the piezoelectric material powder by adding a sol having a different composition for a particular purpose.

The piezoelectric material powder was manufactured by a typical powder manufacturing process. That is, the material powder was mixed by a ball milling for 24 hours in a wet mixing method, dried and calcined, to thereby enhance reactivity. And then, the piezoelectric material powder was milled in an attrition milling method to prepare a particle size of below 0.3 micron.

The method used for the mixing and dispersing process for manufacturing the paste adopted a ball milling method and a three roll milling method and thusly manufactured paste contained 50-85 wt % piezoelectric material powder, 10-25 wt % vehicle and 5-25 wt % sol.

Embodiment 2

Piezoelectric material powder and a sol having the same or similar component as or to that of the piezoelectric powder were mixed and dispersed in a vehicle to fabricate a paste.

The manufactured paste was repeatedly printed on a substrate to have a desired final thickness of 5-100 micron by the typical screen printing method, to thereby form a thick film. The thick film is dried and sintered for a predetermined time period, that is, for example, for 1-30 minutes, at a temperature of 750-950° C., thereby manufacturing a thick film or manufacturing a thick film by quickly thermally processing it within 20 seconds at a temperature of 1000-1200° C.

Embodiment 3

The vehicle was made as in Embodiment 1 above, in which the piezoelectric material powder was mixed and dispersed to fabricate a general piezoelectric material paste without a sol. The paste was repeatedly printed to have a desired final thickness of 5-100 micron on the substrate by the screen printing method, thereby forming a thick film.

The thick film is dried and its organic binder was removed at a temperature of 400-700° C. And then, a sol solution having the same or a similar composition as or to the piezoelectric material powder was coated on the surface of the printed thick film so that the sol solution was infiltrated into the thick film.

Thereafter, a test sample was spun to remove residual sol solution, dried and thermally treated at a temperature of 80-600° C. And then, the resulting test sample was sintered at a temperature of 750-950° C. for a predetermined time period, for example, for 1-30 minutes, to fabricate a thick film or was thermally treated quickly within 20 seconds at a temperature of 1000-1200° to fabricate a thick film.

Embodiment 4

A paste containing a sol having the same or a similar component as or to the piezoelectric material powder manufactured by Embodiment 1 was repeatedly printed to have the desired final thickness of 5-100 micron on the substrate by the screen printing method, to thereby form a thick film.

And then, as in Embodiment 3 above, the thick film was dried to remove an organic solvent at a temperature of 400-700° C. Thereafter, a sol solution was coated on the surface of the printed thick film so that the sol solution was infiltrated into the thick film.

The test sample was spun to remove residual sol solution, dried and thermally treated at a temperature of 80-600° C. And then, the resulting sample was sintered for a predetermined time period, that is, for example, for 1-30 minutes, at a temperature of 750-950° C. to fabricate a thick film, or thermally treated quickly within a 20 seconds at a temperature of 1000-2000° C. to fabricate a thick film.

Embodiment 5

In the process in which the fabricated paste was repeatedly printed on the substrate by the screen printing method in the same manner as those of Embodiments 3 and 4 to have the desired final thickness of 5-100 micron, to thereby form a thick film, every time the paste was screen-printed, a sol having the same or a similar component as or to the piezoelectric material powder was coated and infiltrated on the surface in the same manner as those of Embodiments 3 and 4.

Embodiment 6

A paste was fabricated by adding 5-20% PbO to a paste made as in Embodiments 2 and 3. Other processes are the same as Embodiments 2 and 3. By adding PbO, PbO was prevented from volatilizing while calcining and sintering and the sintering temperature was lowered down due to formation of a liquid phase.

Through Embodiment 1 to 6 above, as for Pb(CdW)O₃—PbTiO₃—PbZrO₃, a piezoelectric characteristic was checked for each composition while varying the ratio of Pb(Cd_{1/2}W_{1/2}) to Pb(Zr,Ti)O₃. The change of each characteristic according to the composition and temperature change of a bulk ceramic itself, a thick film deposited by the screen printing and a sol-processed thick film after the screen printing is as shown in Table 1. In Pb(Zr,Ti)O₃+xPb(Cd_{1/2}W_{1/2})O₃, ‘x’ indicates a ratio of Pb(Cd_{1/2}W_{1/2})O₃ to Pb(Zr,Ti)O₃.

TABLE 1

| | 0.06 | | 0.08 | | 0.10 | | 0.12 | |
|---|---|---|---|---|---|---|---|---|
| Composition (x) | Dielectrio | Plezoelectric | Dielectric | Piezoelectric | Dielectric | Piezoelectric | Dielectric | Piezoelectric |
| Temperature | constant | constant (d₃₃) | constant | constant (d₃₃) | constant | constant (d₃₃ ) | constant | constant (d₃₃) |
| 900 | 1165 | 125 | 940 | 108 | 1638 | 120 | 1044 | 152 |
| | | | (629) | (130) | (773) | | | (169) |
| | | | [815] | [291] | | | [1024] | [339] |
| 950 | 1328 | 118 | 1146 | 111 | 1133 | 214 | 1166 | 214 |
| | | | (696) | (151) | | | (864) | (184) |
| | | | [952] | [256] | | | [1165] | [347] |
| 1000 | 1075 | 253 | 1039 | 280 | 1090 | 228 | 1029 | 187 |
| 1050 | 1080 | 280 | 1054 | 240 | 1023 | 171 | 1006 | 177 |

( ): a thick film deposited by the screen printing
[ ]: sol-processed thick film after the screen printing

As shown in Table 1, it is noted that in case of the bulk ceramic, when ‘x’=0.12, if the sintering temperature is raised to higher than 1000° C., the value ‘d₃₃’ (piezoelectric constant) is lowered down compared to the case that ‘x’=0.08, but the value ‘d₃₃’ is sharply increased from 111 to 214 at the temperature of 950° C.

Also, in case of the thick film deposited by the screen printing and the thick film which was sol-processed after screen printing, the value ‘d₃₃’ is increased from 151 to 184 and from 256 to 345, respectively.

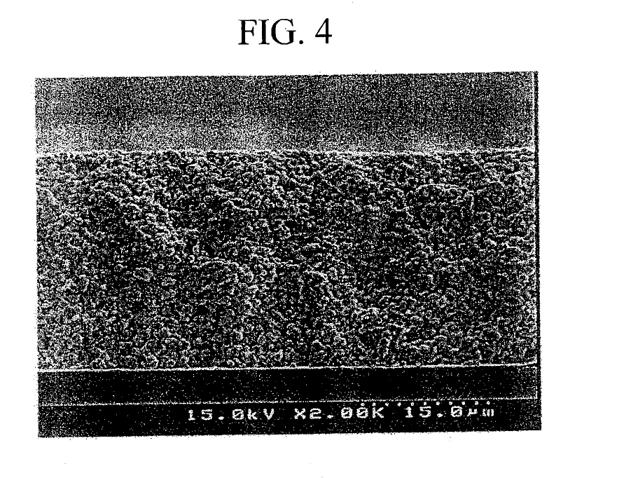

FIG. 4 shows the section of the PZT+0.12Pb(Cd_{1/2}W_{1/2})O₃ thick film deposited according to Embodiment 4, exhibiting the excellent interface characteristic from the result that no reaction was made between the thick film and the lower Si substrate.

### Comparative Example 1

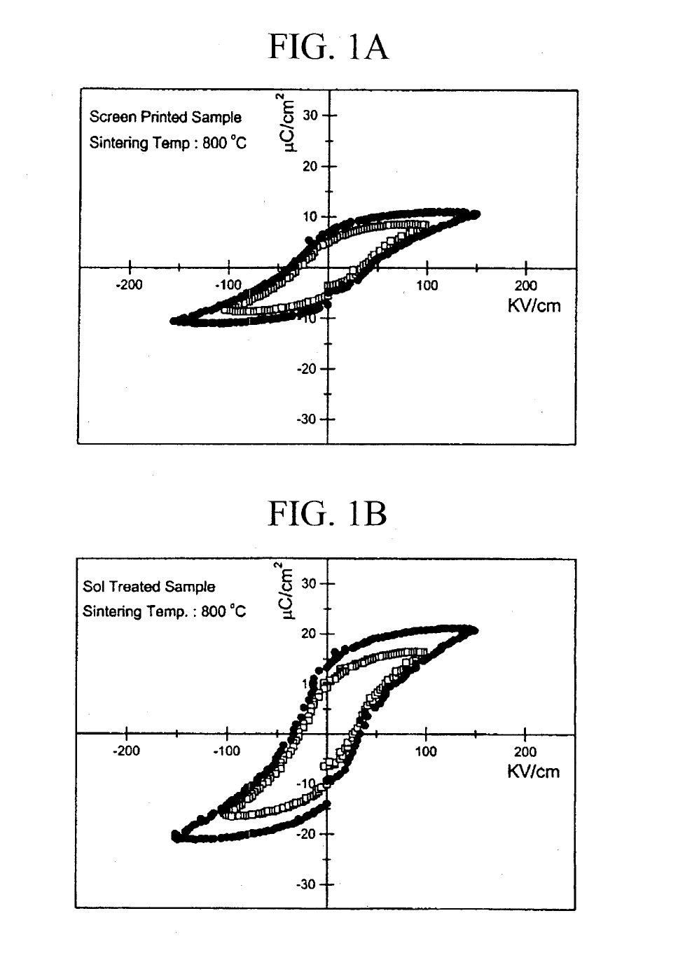

A polarization-electric field (P-E) hysteresis curve for a sample before sol-processing of a pure PZT thick film (thermal treatment temperature: 800° C.) and a polarization electric field hysteresis curve for a sample after sol-processing were compared (FIGS. 1A and 1B).

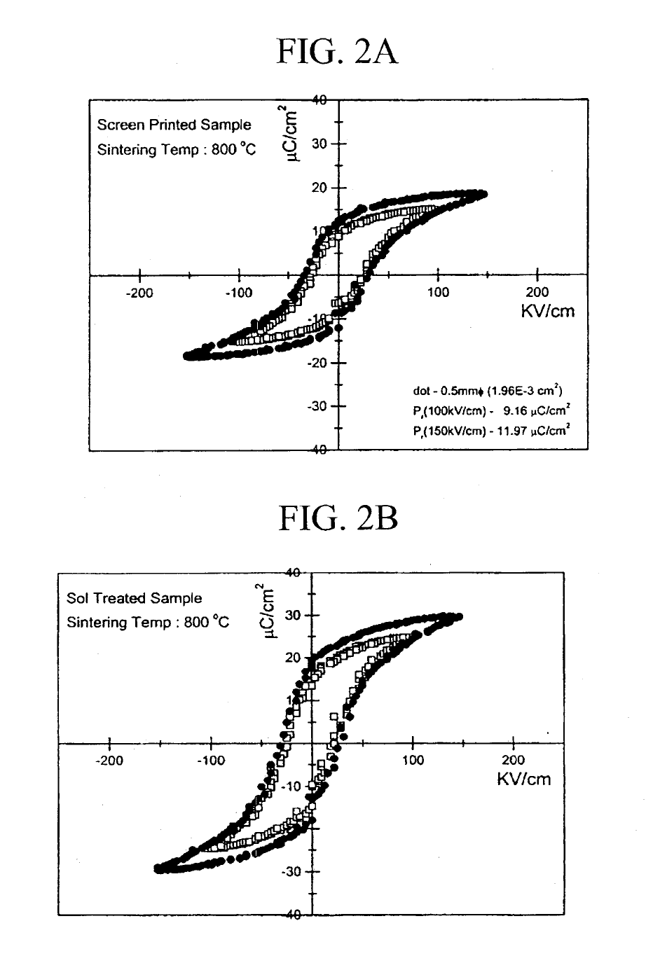

A polarization-electric field (P-E) hysteresis curve for a sample before sol-processing of a PZT-0.08PCW thick film according to the method of the present invention (thermal treatment temperature: 800° C.) and a polarization electric field hysteresis curve for a sample after sol-processing were compared (FIGS. 2A and 2B).

As shown in FIGS. 1 and 2, comparison between the thick film deposited by the screen printing and the simple PZT disclosed in the Korean Patent Application No. 00-25622 reveals that the characteristic of the thick film made of the material of the present invention is superior, and if the thick film is sol-processed like in Korean Patent. Application No. 00-25622, its characteristic is more improved than before sol-processing.

### Comparative Example 2

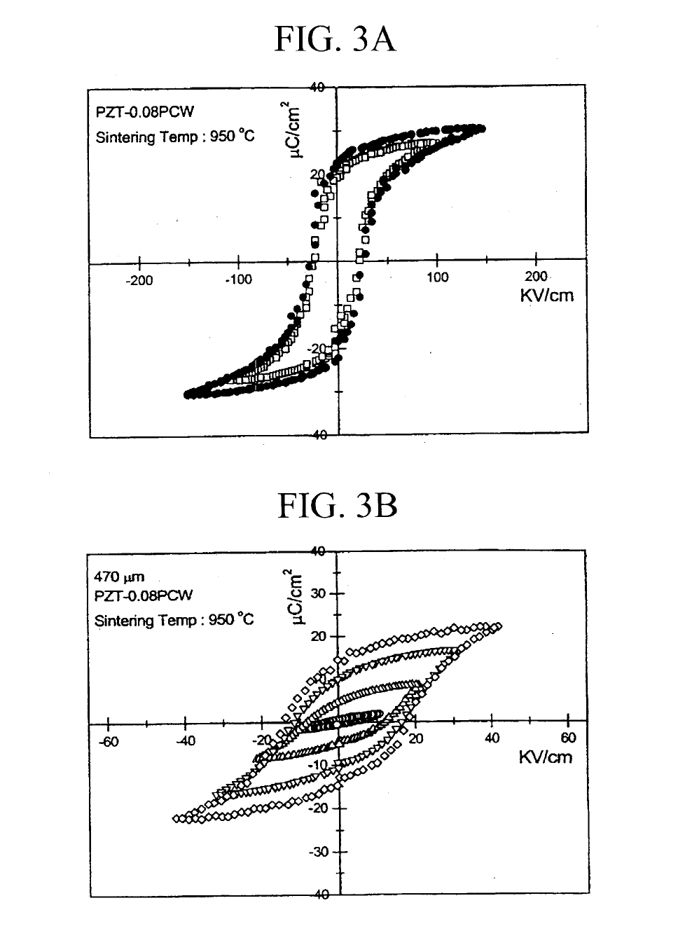

A polarization-electric field (P-E) hysteresis curve for a sample deposited by a pure screen printing before sol-processing of a PZT-0.08PCW thick film according to the method of the present invention (thermal treatment temperature: 950° C.) and a polarization electric field hysteresis curve of a bulk PZT-0.08PCW test sample (thermal treatment temperature 950° C.) were compared as shown in FIGS. 3A and 3B. It is noted that the residual polarization value of the thick film (FIG. 3A) according to the present invention is excellent compared than that of the bulk material (FIG. 3B) which was subjected to a thermal treatment at a temperature of 950° C.

### Comparative Example 3

The bulk test sample, the thick film before sol-processing and the thick film with sol infiltrated were sintered at the temperature of 950° C. and each electric characteristic change was compared, a result of which is as shown in below Table 2. It is also noted that, compared to the bulk state, when they were deposited as a thick film, they exhibit more excellent characteristic with the material of the present invention.

TABLE 2
Changes in electric characteristics of each of bulk, the thick film and the
thick after sol is infiltrated, having a PZT-0.08 PCW composition

| | | Thick film | Thick film |
|---|---|---|---|
| | Bulk test sample | before sol-processing | after sol-processing |
| Dielectric constant | 1147 | 725.5 (100 kHz) | 1003.4 (100 kHz) |
| Dielectric loss | 0.215 | 0.0049 (100 kHz) | 0.0052 (100 kHz) |
| Residual polarization | 14.70 (42 kV/cm) | 22.04 (150 kV/cm) | 30.06 (150 kV/cm) |
| (μ C/cm²) | | | |
| Piezoelectric constant | 276 | 190 | 260 |
| (d₃₃) | | | |

As so far described, the piezoelectric thick film can be obtained having a composition which is sintered at a low temperature compared to that of the conventional art, and thus, a high density piezoelectric thick film having a low reactivity with a bottom substrate can be fabricated by using the screen printing method.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A high density piezoelectric thick film of which a composition of a piezoelectric material is Pb(Zr,Ti)O₃+xPb(Cd_{1/2}W_{1/2})O₃(x=0.01-0.20).

2. A method for manufacturing a high density piezoelectric thick film comprising the steps of:
mixing and dispersing piezoelectric material powder and a sol in a vehicle made of an organic binder and solvent, to fabricate a paste;
printing the paste to a thickness of 5-100 micron on a substrate by a screen printing, to form a thick film;
drying the thick film; and
thermally treating the thick film.

3. A method for manufacturing a high density piezoelectric thick film comprising the steps of:
mixing and dispersing piezoelectric material powder in a vehicle made of an organic binder and solvent, to fabricate a paste;
printing the paste to a thickness of 5-100 micron on a substrate by a screen printing, to form a thick film;
drying the thick film and removing the organic binder;
coating and infiltrating a sol solution on the surface of the printed thick film;
spinning a test sample to remove a residual sol solution;
drying and intermediately thermally treating the thick film; and
thermally treating the thick film.

4. A method for manufacturing a high density piezoelectric thick film comprising the steps of:
mixing and dispersing piezoelectric material powder and a sol in a vehicle made of an organic binder and solvent, to fabricate a paste;
printing the paste to a thickness of 5-100 micron on a substrate by a screen printing, to form a thick film;
drying the thick film and removing the organic binder;
coating and infiltrating a sol solution on the surface of the printed thick film;
spinning a test sample to remove a residual sol solution;
drying and intermediately thermally treating the thick film; and
thermally treating the thick film.

5. The method of one of claim 2 to 4, wherein the piezoelectric material powder has the basic component of Pb(Zr,Ti)O₃+xPb(Cd_{1/2}W_{1/2})O₃(x=0.01-0.20).

6. The method of claim 5, wherein the sol has the same or a similar component as or to that of the piezoelectric material powder.

7. The method of one of claim 2 to 4, wherein the organic binder is butoxy ethoxy ethyl acetate (BEEA), polyvinyl butyral (PVB) or polyethylene glycol (PEG).

8. The method of one of claim 2 to 4, wherein a solvent is α-terpineol.

9. The method of one of claim 2 to 4, wherein the thermal treatment is performed for 1-30 minutes at a temperature of 750-950° C.

10. The method of one of claim 2 to 4, wherein the thermal treatment is performed within 20 seconds at a temperature of 1000-1200° C.

11. The method of one of claim 2 to 4, wherein the substrate is a silicon substrate, a ceramic and a single crystal substrate such as ZrO₂ or Al₂O₃, a ceramic substrate with a metal such as platinum coated thereon, or a metal substrate with ceramic coated thereon.
